(19) United States
(12) Patent Application Publication
(10) Pub. No.: US 2017/0002223 A1
(43) Pub. Date: Jan. 5, 2017

(54) COLORED PLATELETS

(71) Applicant: SILBERLINE MANUFACTURING COMPANY, INC., Tamaqua, PA (US)

(72) Inventors: Shufang YU, Orefield, PA (US); Peter Lloyd REDMOND, New Ringgold, PA (US); Rajasekar PITCHIMANI, Breinigsville, PA (US); Hai Hui LIN, Naperville, IL (US); Parfait Jean Marie LIKIBI, Mount Pleasant, SC (US)

(21) Appl. No.: 15/092,189

(22) Filed: Apr. 6, 2016

Related U.S. Application Data
(63) Continuation of application No. 13/332,855, filed on Dec. 21, 2011, now abandoned.

(51) Int. Cl. C09D 17/00; C09D 11/00; C09D 7/12

(52) U.S. Cl. CPC C09D 17/003; C09D 7/1291; C09D 11/00

(57) ABSTRACT

A colored platelet including a substrate, an adhesion layer, a color pigment layer, and a secure layer and a method of producing the colored platelet are described. The disclosed colored platelet can provide a superior bright color effect in a coating composition. The color effect can depend on the material used for the substrate and/or the color pigment layer.

### FIELD

This disclosure generally relates to effect pigments, and particularly, to the design of effect pigments and methods of producing the effect pigments.

### BACKGROUND

Effect pigments can include coated aluminum flakes or coated mica flakes. The former can exhibit a metallic effect while the latter can exhibit a pearlescent effect. In recent years, the need for colored effect pigments has increased greatly.

Methods for producing colored effect pigments have been described. For example, U.S. Pat. No. 6,599,355, U.S. Pat. No. 6,500,251 and U.S. Pat. No. 6,648,957 disclose a method in which a platelet substrate is coated with high refractive index metal oxide layers which include TiO₂, Zr₂O₃ and Fe₂O₃ or with alternating layers of high and low refractivity. US 2011/0126735, U.S. Pat. No. 5,116,664, U.S. Pat. No. 6,794,037, U.S. Pat. No. 6,325,847, U.S. Pat. No. 5,308,394 and U.S. Pat. No. 6,800,125 disclose a coating with a metal particle layer as a reflective layer.

The use of organic molecules to create colors also has been disclosed. For example, U.S. Pat. No. 5,931,996 is directed to a colored aluminum pigment that includes flake-form aluminum substrates which are coated with a metal oxide layer derived from a metal acid ester, where the single layer of metal oxide contains at least one color pigment. The process of making the pigment involves mixing a ground color pigment with aluminum flakes in the presence of a solvent.

U.S. Pat. No. 5,037,475 discloses a method of producing a colored metallic pigment. In this method, a double bond-containing carboxylic acid polymer initially is absorbed onto a surface of a metal pigment, and then a color pigment is absorbed on the modified surface.

EP 0 278 633 B1 (U.S. Pat. No. 4,755,229) describes the preparation of colored platelets based on mica in which a polymer including anionic groups is precipitated in the presence of mica and an color pigment by the addition of a cationic polyvalent metal.

U.S. Pat. No. 6,203,909 B1 relates to a composite pigment that includes a substrate and a colorant in which the substrate and the colorant are each coated with ions or ionisable compounds. The charge of the substrate coating is opposite to the charge of the colorant coating.

U.S. Pat. No. 6,113,683 relates to a colored pearlescent pigment that includes a pearlescent pigment and a second pigment in which a polymer containing hydroxyl groups is used as an adhesion promoter for the mutual absorbance of the pearlescent pigment with the second pigment.

U.S. Pat. No. 5,156,678 describes an effect pigment that includes interference pigments coated with organic dyes, where the dye is a film directly adhering to the interference pigment without the aid of binders or other auxiliary materials.

U.S. Pat. No. 6,533,858 relates to a colored platelet that includes platelet substrates whose surface is coated with a first layer including anionic polymer and water-insoluble colored platelets, and a second layer including hydrated aluminum oxide or combination of a hydrated aluminum-cerium oxide and a coating of a hydrolyzed silane coupling agent.

The above-mentioned colored platelets have either low color density for the desired color effects, or have a solvent bleeding problem.

### SUMMARY

A colored platelet that can provide superior color effects, and a method of producing the colored platelet are disclosed. The disclosed method can be used to obtain the disclosed colored platelet and can provide a cost-effective approach to produce a colored platelet.

The disclosed colored platelet can include a substrate, an adhesion layer, a color pigment layer and a secure layer. The substrate used can be opaque and transparent, and can include metals such as aluminum, metal oxides such as aluminum oxide, synthetic silica, mica, zeolite, glass etc. In one example, the adhesion layer includes an organic layer. In one instance, the adhesion layer is an organic monolayer. In another instance, the adhesion layer is a quaternized layer.

In one embodiment, the disclosed method includes forming an adhesion layer on the substrate, attaching color pigment on the adhesion layer and then forming a secure layer. In one instance, forming the adhesion layer includes adding a quaternizing agent to an organic layer including tertiary amines that is formed on the substrate.

The disclosed colored platelet can be used in coatings, inks, plastics, and other general industrial coatings.

### BRIEF DESCRIPTION OF THE DRAWINGS

FIGS. 1A and 1B are schematic drawings of some embodiments of the disclosed colored platelet.

FIGS. 2A and 2B are schematic drawings of the embodiments shown in FIGS. 1A and 1B.

FIGS. 3A and 3B show the SEM images of the disclosed colored platelet surface at high magnification (100 K). FIG. 3A is the image of the surface of the substrate included in the disclosed colored platelet before coating. FIG. 3B is the surface of the disclosed colored platelet after multilayer coating.

### DETAILED DESCRIPTION

A colored platelet including a substrate, an adhesion layer, a color pigment layer, and a secure layer and a method of producing the colored platelet are described. The use of the disclosed colored platelet in a coating composition can lead to a superior bright color. The color effect obtained by using the disclosed colored platelet can depend on the material used for the substrate and/or the color pigment layer that includes color pigments. The term “platelet” herein means transparent, metallic, white or colored, mineral or color pigment of any form, which are insoluble in a liquid medium and are suitable for use in ink, paint and plastic compositions. The term “color pigment” means an inorganic or organic particle that imparts color.

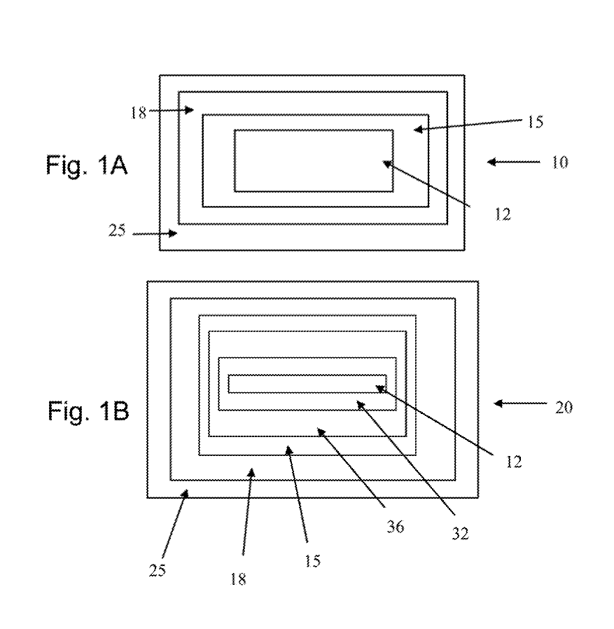

With reference to FIG. 1A, a colored platelet 10 includes a substrate 12. In one example, the substrate can be an encapsulated platelet. The size of the substrate 12 can be any size that is suitable for forming an effect pigment. In one implementation, the substrate 12 can have a diameter in the range of 5 μm to 700 μm, and a thickness of 5 nm to 500 nm. The diameter and thickness can be measured using Field Emission Scanning Electron Microscopy (FESEM). In this instance, the diameter is measured as viewed from a top view of the substrate, and the thickness is measured as viewed in cross-sectional side view of the substrate.

In one instance, the substrate 12 can be any material that is suitable for forming an effect pigment, including non-metal and metal substrates. In one example, the substrate is a non-metal substrate. The term “metal” herein means that the oxidation state of the element metal present in the substrate is zero. The term “non-metal” herein means that the oxidation state of the element present in the substrate is other than zero. The substrate 12 can include glass, silicon oxide, and mica. In other examples, the substrate 12 can include a metal such as aluminum and a metal oxide such as aluminum oxide. In some instances, the material used for the substrate 12 can determine the color effects of the colored platelet 10, as explained more in detail below.

The substrate 12 can be surrounded by an adhesion layer 15. In one instance, the adhesion layer 15 is an organic monolayer. The term “organic monolayer” herein means a layer that includes a molecule with an organic chain, for example, a heteroorganic compound that includes about 2 to about 30 carbon atoms on the primary chain. The heteroorganic compound can include an amino group. In some examples, the heteroorganic compound is a hydrolysate of a hydrolysable compound. In some instances, the hydrolysable compound is an aminosilane.

In one example, the organic monolayer 15 can include an aminosilane monolayer. Examples of an aminosilane that can be utilized include 3-(N,N-dimethylaminopropyl) trimethoxysilane, (N,N-dimethyl-3-aminopropyl) methyldimethoxysilane, (dimethylamino)methylethoxysilane, N-n-butyl-aza-2,2-dimethyoxysilacyclopentane, bis(3-trimethoxysilylpropyl)-N-methylamine, N-allyl-aza-2,2-dimethoxysilacyclopentane, bis(2-hydroxyethyl)-3-aminopropyltriethoxysilane, N,N′-bis(hydroxyethyl)-N,N′-bis(trimethoxysilylpropyl)ethylenediamine and bis(methyldimethoxysilylpropyl)-N-methylamine.

In one instance, the amount of the aminosilane included in the organic monolayer 15 is in the range of 0.1 to 20% by weight based on the weight of the starting substrate 12 when producing the colored platelet 10.

In one example, an organic chain included in the organic monolayer 15 can contain a tertiary amine group. The tertiary amine group can be included anywhere along the organic chain, for instance, in the middle of the organic chain or at the end of the organic chain.

In some examples, the thickness of the adhesion layer 15 can be in a range of 0.01 nm-50 nm.

The adhesion layer 15 can be further coated with a color pigment layer 18. The color pigment layer 18 can include a color pigment. The color pigment can be, but is not limited to, quinacridone, perylene, perinone, thioindigo pigments, azo pigments, diazo pigments, benzimidazole pigments, naphthene pigments, metal complex pigments, isoindolinone pigments, isoindoline pigments, indigo, quinophthalone pigments, dioxazine pigments, anthraquinone, and diketopyrrolopyrrole (DPP).

The color pigment included in the color pigment layer 18 can have a diameter of 0.1 nm to 200 nm. In one instance, the color pigment layer 18 includes color pigments that are nanoparticles having an average particle size of 0.1 nm to 200 nm.

In another embodiment, the adhesion layer 15 can include a quaternized amine group that enhance charge-to-charge interaction between the adhesion layer 15 and the color pigment in the color pigment layer 18. The term “quaternized” herein means that a quaternizing agent of a small molecular reactant is chemically bound to a tertiary amine group to produce a quaternary amine. The term “quaternary amine” herein means a cationic amine salt in which the nitrogen atom has four groups bonded to it and carries a positive charge.

The quaternizing agent can be an alkyl halide having a formula R—X where R is an alkyl group and X is a halide. In one example, X is Cl, Br, or I. In another example, the quaternizing agent can be dipropyl carbonate, dibenzyl carbonate, diethyl carbonate or dimethyl carbonate.

The color pigment layer is further coated with a secure layer 25. In one example, the secure layer 25 is an oxide layer. The secure layer 25 can function to secure the particles on the surface of the colored platelet 10. The secure layer 25 can include SiO₂, TiO₂, and/or ZrO₂. In other examples, the secure layer 25 can be a metal particles layer or a polymer layer. The metal particles layer can include silver, copper and/or nickel. The polymer layer can include polystyrene (PS), polymethylmetacrylate (PMMA), polymethacrylate (PMA), 2-hydroxy ethyl methacrylate, glycidyl methacrylate, and/or dimethylamino ethyl methacrylate.

The colored platelet 10 can be further coated with an optional layer (not shown) for use with a desired resin system. For example, the colored platelet 10 can be coated with an organic layer with hydrophilic functional groups, thereby improving compatibility with water-borne resin systems.

With reference to FIG. 1B, in another embodiment, a colored platelet 20 includes the substrate 12. In one implementation, the substrate 12 of the colored platelet 20 includes a functional group on the surface of the substrate 12. The functional group can be any functional group that is suitable for silanization of the surface of the substrate 12. In one instance, the functional group can be a hydroxyl group. In one implementation, the substrate 12 is a glass flake.

The substrate 12 can be coated with a first oxide layer 32. The first oxide layer 32 can include, but is not limited to, SiO₂, TiO₂, ZrO₂ and Fe₂O₃. In one implementation, the substrate 12 includes mica, and the first oxide layer includes Fe₂O₃ or TiO₂.

The first oxide layer 32 can be further coated with a second oxide layer 36. The second oxide layer can include SiO₂, TiO₂, or ZrO₂.

The second oxide layer 36 can be coated with the adhesion layer 15. In one example, the second oxide layer 36 can be used to increase the attachment efficiency of the adhesion layer 15.

The adhesion layer 15 can be further coated with the color pigment layer 18, and the color pigment layer 18 can be coated with the secure layer 25.

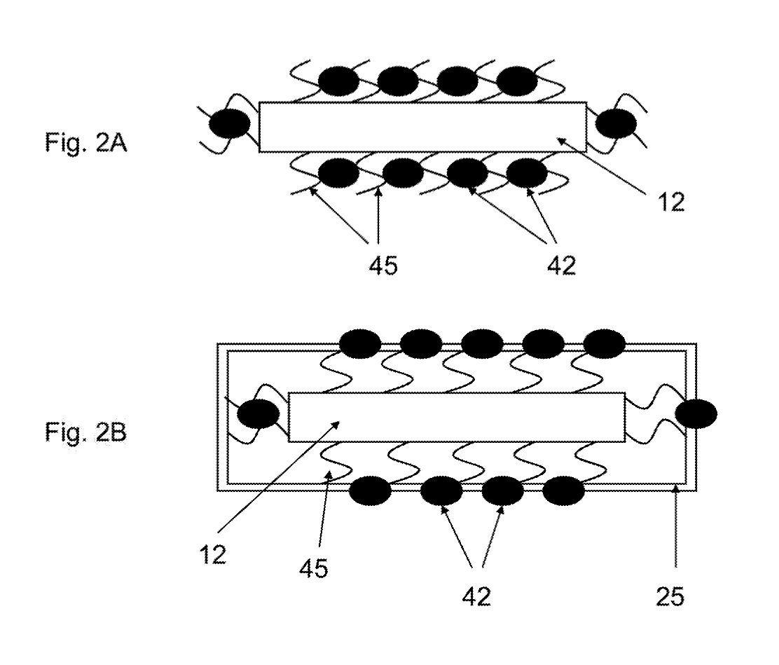

FIGS. 1A and 1B illustrate the color pigment layer 18 as being separated from the adhesion layer 15 and the secure layer 25. However, as shown in FIGS. 2A and 2B, it is to be realized that the color pigment layer 18 includes color pigment particles 42 that are attached to organic chains 45 included in the adhesion layer 15, and the attachment site can be anywhere along each of the organic chains 45, for example, in the middle of the organic chain as shown in FIGS. 2A and 2B. As such, the components of the color pigment layer 18 can be present within the adhesion layer 15 and/or the secure layer 25. It is also to be realized that each of the organic chains 45 can have various orientations.

The disclosed method for preparing the disclosed color platelet can include mixing the substrate 12 and glycol ether in a reactor. The amount of the substrate 12 added can be, but is not limited to a percentage range of 1% to 30% based on the final slurry weight, preferably in the range of 5% to 20%.

After mixing the substrate and glycol ether, which can be done at room temperature, a catalyst such as a base and/or water is added for the following silanization including foaming a silica layer and adhesion layer. Then the reactor temperature can be raised to 40° C.-60° C. A silica layer forming reagent can be optionally introduced into the mixture. Then the reaction temperature can be heated to 70° C.-80° C. for 1 hour.

The silica layer forming reagent can be, but is not limited to, tetraethyl orthosilicate, and tetramethyl orthosilicate. The amount of the silica layer forming reagent and the catalyst added are in the range of 0.1%-10% for the silica layer forming agent on the weight of starting substrate and 1%-20% for catalyst.

After the above reaction has completed, an organic monolayer forming reagent can be introduced into the mixture. The organic monolayer forming reagent can include an amino silane. The amino silane that can be used include 3-(N,N-dimethylaminopropyl) trimethoxysilane, (N,N-dimethyl-3-aminopropyl)methyldimethoxysilane, (dimethylamino) methylethoxysilane, N-n-butyl-aza-2,2-dimethyoxysilacyclopentane, bis(3-trimethoxysilylpropyl)-N-methylamine, N-allyl-aza-2,2-dimethoxysilacyclopentane, bis(2-hydroxyethyl)-3-aminopropyltriethoxysilane, N,N′-bis(hydroxyethyl)-N,N′-bis(trimethoxysilylpropyl)ethylenediamine, and bis(methyldimethoxysilylpropyl)-N-methylamine. The amount of the organic monolayer forming reagent added can be, but is not limited to, in the range of 0.1%-10% on the weight of starting substrates. The mixture including the organic monolayer forming reagent can be stirred and then heated to about 75° C.

Then, the color pigment layer 18 can be formed by adding a color pigment dispersion to the above mixture. The color pigment dispersion can be prepared by mixing a color pigment to glycol ether PM acetate and shaking the mixture for several hours. The color pigment that can be used include quinacridone, perylene, perinone, thioindigo pigments, azo pigments, diazo pigments, benzimidazole pigments, naphthene pigments, metal complex pigments, isoindolinone pigments, isoindoline pigments, indigo, quinophthalone pigments, dioxazine pigments, anthraquinone and diketopyrrolopyrrole (DPP).

The amount of the color pigment added can be in the range of 0.1% to 20% on the weight of substrate. In one instance, the color pigment is added in an amount of 7.2 weight percent based on the weight of the substrate.

The mixture including the color pigment dispersion can be stirred. In one instance, a silica layer forming reagent can be further added to the mixture.

Optionally, a quaternizing agent can be further added to the mixture before the color pigment dispersion is added to enhance or adjust the interactions between the color pigment and the substrate 12. The quaternizing agent used can be an alkyl halide having a formula R—X where R is an alkyl group and X is a halide. In one instance, X is Cl, Br, or I. In another instance, the quaternizing agent can be dipropyl carbonate, dibenzyl carbonate, diethyl carbonate or dimethyl carbonate. In one example, an alkyl or aryl bromide is used with a coating that includes poly(N,N-dimethylaminoethylmethacrylate) (PDMAEMA). In this example, the tertiary amine group of the coated substrate is quaternized by the bromide, thereby providing a positive charge to the adhesion layer 15. As a result, the adhesion between the adhesion layer 15 and the negatively charged color pigments is enhanced. It is to be realized that the selection of materials, such as alkyl chains, within the coating of the coated substrate can greatly influence the adsorption kinetics and the final performance of the colored platelet. For example, use of longer chains in the alkyl or aryl bromide may increase the hydrophobicity, incorporation of polar groups such as hydroxyls into the alkyl or aryl bromide may increase the hydrophilicity, etc.

In the instance where the quaternizing agent is used, the color pigment layer is formed by charge reaction—electrical interaction with the adhesion layer 15 where the color pigment has negative zeta potential. The zeta potential is a consequence of the existence of surface charge on the particles.

Once the above reaction has completed, the reaction mixture is cooled. In one example, the mixture is cooled to below 30° C. The mixture is then filtered, for example, using vacuum filtration over a Buchner funnel. The resulting paste is then washed with glycol ether PM acetate, and then collected.

It is to be realized that the above mentioned reaction conditions and reaction times for the disclosed method can be adjusted after considering the reagents used.

In yet another embodiment, the colored platelet 10 or 20 may be used in a coating composition. The coating composition includes the colored platelet 10 or 20 and a carrier. The “carrier” component includes the blend of base liquid or solvent, film-forming components, and related additives. Carriers include, but are not limited to, the following: acrylic emulsions, water reducible alkyl resin systems, water reducible alkyl/melamine cross-linked systems, waterborne epoxy systems, polyester emulsions, and water reducible polyester/melamine coatings. In some instance, the carrier can be a varnish. The term “varnish” herein means a resin mixture following the ISO 12944 standards in a blend of solvents. The varnish can include acrylic resins. In other examples, the coating composition can further include a thinner. The term “thinner” herein means a blend of fast drying organic solvents, such as aromatic or ketone solvents.

In some instances, the disclosed colored platelet provides superior color effects in a coating composition, and the color effects are determined by the material that is used in the disclosed colored platelet. The term “color effect” herein means a colorimetric appraisal using the CIE lab color space system defined by the Commission Internationale de l'éclairage (CIE). CIElab values are measured with a multi-angle spectrophotometer having an illumination of D65 and an observer angle of 10° at different angles of 15°, 25°, 45°, 75° and 110° following the ASTM E-2194 and DIN 6175-2 standards. The color coordinates (L, a*, b*) are related to lightness (L) and color (a* and b*). The a* is the red/green content and b* is the blue/yellow content.

In one example, the disclosed colored platelet can provide a color effect that is bright red. In one implementation, the colored platelet that provides the bright red color effect can include a substrate 12 that is mica. The substrate 12 can be surrounded by an oxide layer 32 that includes iron oxide. Other useful materials for the substrate that can be used in the colored platelet for providing the red color effect include iron oxide coated aluminum. In the instance where iron oxide coated mica is used, the iron oxide coated mica can be coated with a silica layer, and the silica layer can be surrounded by an adhesion layer 15. In one example, the adhesion layer 15 can include the materials indicated above for the pigment 10, including an aminosilane. The adhesion layer 15 can be surrounded by a color pigment layer 18 that can include color pigments. Suitable color pigments that can be used in the colored platelet for providing the red color effect include, but are not limited to, quinacridone, perylene, anthroquinone, diketo-pyrrolo pyrrole, and dioxazine.

The term “bright red color effect” herein means that a colorimetric appraisal using the CIE lab color space system is bright red, e.g., having the following CIE lab values as measured with a multi-angle spectrophotometer where the illumination is D65 and the observer angle is 10°:

| Angle, as defined by ASTM | | | |
|---|---|---|---|
| E-2194 and DIN 6175-2 | L | a* | b* |
| 15° | 73-76 | 77-80 | 18-21 |
| 25° | 56-59 | 63-66 | 16-19 |
| 45° | 32-35 | 44-47 | 19-22 |
| 75° | 24-27 | 40-43 | 26-29 |
| 110° | 23-26 | 40-43 | 27-30 |

In one example, the disclosed colored platelet can provide a color effect that is bright dark blue. In one implementation, the colored platelet that provides the bright dark blue color effect can include a substrate 12 that is titania-coated mica. Other useful materials for the substrate 12 that can be used in the colored platelet for providing the bright dark blue color effect include aluminum, glass, metal oxide coated substrates. In the instance where titania-coated mica is used in the substrate 12, the titania-coated mica substrate 12 can be coated with an adhesion layer 15. In one example, the adhesion layer 15 can include the materials indicated above for the pigment 10, including an aminosilane. The adhesion layer 15 can be surrounded by a color pigment layer 18 that can include color pigments. Suitable color pigments that can be used in the colored platelet for providing the bright dark blue color effect include, but are not limited to, phthalocyanine, Prussian blue, and cobalt blue.

The term “bright dark blue color effect” herein means that a colorimetric appraisal using the CIE lab color space system is bright dark blue, e.g., having the following CIE lab values as measured with a multi-angle spectrophotometer where the illumination is D65 and the observer angle is 10°:

| Angle following the ASTM | | | |
|---|---|---|---|
| E-2194 and DIN 6175-2 | | | |
| standards | L | a* | b* |
| 15° | 98-100 | −12~−14 | −50~−52 |
| 25° | 79-81 | −20~−22 | −20~−22 |
| 45° | 69-71 | −22~−24 | −1~−3 |
| 75° | 69-71 | −24~−26 | 0~−1 |
| 110° | 68-70 | −28~−30 | −6~−8 |

In another embodiment, the colored platelet 10 or 20 may be used in a coating in an article. The article includes a coating that includes the colored platelet 10 or 20.

### EXAMPLES

### Example 1

Dispersion of color pigment particles in PM acetate

5.4 g of quinacridone color pigment was added in an aluminum can and then, glycol ether PM acetate was added. After this, the mixture was shaken for 2 hours with a paint shaker to make a 4% color pigment dispersion.

### Example 2

75 g of iron oxide coated mica with a particle size of 10-60 μm (D50=25 μm) in 1 liter reaction vessel with a condenser was dispersed in 400 g glycol ether PM acetate while stirring. After 30 minutes, 5% of water and 4% of ammonia on iron oxide coated mica by weight were added into the dispersion and the resulting mixture was stirred for 30 minutes. Then, the temperature of the mixture was increased to 50° C. 6% of tetraethyl orthosilicate (TEOS) was then added while stirring. After this, the temperature was increased to 75° C. and kept for one hour. Then 2% of 3-(N,N-dimethylaminopropyl) trimethoxysilane was added and the mixture was stirred for one hour. The color pigment dispersion from example 1 was added and the mixture was stirred for 30 minutes. A second part of TEOS 12% was then added into the mixture. After one hour, the slurry was filtered and washed with glycol ether PM acetate three times.

### Example 3

Same as example 2, except that 75 g of iron oxide coated mica was dispersed in glycol ether PM, and glycol ether PM was used for the final wash.

### Example 4

75 g of iron oxide coated mica with a particle size of 10-60 μm (D50=25 μm) in 1 liter reaction vessel with a condenser was dispersed in 400 g glycol ether PM acetate while stirring. After 30 minutes, 5% of water and 4% of ammonia of iron oxide coated mica by weight was added into the dispersion and the mixture was stirred for 30 minutes. Then, the temperature was increased to 50° C., and 6% of tetraethyl orthosilicate (TEOS) was added while stirring. After this, the temperature was increased to 75° C. and kept for one hour. Then 2% of 3-(N,N-dimethylaminopropyl)trimethoxysilane was added and the resulting mixture was stirred for one hour. Then, 2% of dipropyl carbonate was added and stirred for one hour. The color pigment dispersion from example 1 was then added and the resulting mixture was stirred for 30 minute. A second part of TEOS 12% was then added in the mixture. After one hour, the slurry was filtered and washed with glycol ether PM acetate three times.

### Example 5

75 g of titanium oxide coated mica with a particle size of 10-60 μm with a two tone color was dispersed in 400 g glycol ether PM acetate while stirring. After 30 minutes, 4% of ammonia on titanium oxide coated mica by weight was added into the dispersion and stirred for 30 minutes. Then, the temperature was increased to 50° C., and 6% of tetraethyl orthosilicate (TEOS) was added while stirring. After this, the temperature was increased to 75° C. and kept for one hour. Then, 2% of 3-(N,N-dimethylaminopropyl) trimethoxysilane was added and the mixture was stirred for one hour. The color pigment dispersion from example 1 was added and the mixture was stirred for 30 minutes. A second part of TEOS 12% then was added into the dispersion. After one hour, the slurry was filtered and washed with glycol ether PM acetate three times.

### Example 6

### Dispersion of Color Pigment Particles in PM Acetate

5.4 g of phthalocyamine blue pigment was added in an aluminum can and then, glycol ether PM acetate was added. The can was shaken for 2 hours with a paint shaker to make a 4% color pigment dispersion.

### Example 7

2 g of titania coated mica substrate with a light blue color was dispersed in 18 g glycol ether PM acetate while stirring. After 30 minutes, 4 g of the organic pigment dispersion from example 6 was added and stirred for 30 min. Then 0.25 g of 3-(N,N-dimethylaminopropyl)trimethoxysilane and 0.2 g dipropyl carbonate was added and the mixture was stirred for 30 min. Then, 0.5 g of water was added and stirred for 30 min. After this, the temperature was increased to 75° C. and kept for one hour. Then, 0.5 g of tetraethyl orthosilicate (TEOS) was added while stirring. After one hour, the slurry was filtered and washed with glycol ether PM acetate three times. The resulting pigment was very bright and darker blue than the initial lighter blue substrates that was initially added.

### Example 8

To evaluate the color effects provided by the colored pigments obtained in Example 2, 1 g of the colored platelet prepared in Example 2 was mixed with a proprietary automotive refinish resin system including three parts of varnish and one part of thinner. The final paint had a pigment content of 17% by weight. The final paint was dispersed for 30 seconds in the Speedmixer (DAC 150 FVZ-K) from Flackteck Inc. A drawdown bar (#14) was used to prepare drawdowns of the pigmented varnish on a piece of black and white ink cardboard. The film was dried in an oven at a temperature of 95° F., then a clear coat was applied on top of the film with three parts of varnish and one part of thinner. CIELab values were measured with X-rite MA68II Multi-angle Spectrophotometer at an angle difference of 15°, 25°, 45°, 75° and 110°. The reported color coordinates (L, a*, b*) were measured under an illumination of D65 and a viewing angle of 10°. L is lightness, a* is the red/green content and b* is the blue/yellow content. The measurements were carried out on single drawdowns over a white background as shown in Table 1 (sample from example 2).

### Comparative Example 8

Same as Example 8, except that 1 g of the starting iron oxide coated mica in Example 2 instead of the colored platelet prepared in Example 2 was used. The results of the CIELab measurements are shown in Table 2.

TABLE 1

| Sample from Example 2 | | | |
|---|---|---|---|
| (Angle following the ASTM | | | |
| E-2194 and DIN 6175-2 | | | |
| standards) | L | a* | b* |
| 15° | 74.34 | 78.43 | 20.03 |
| 25° | 57.17 | 63.83 | 18.05 |
| 45° | 33.06 | 45.59 | 21.03 |
| 75° | 25.27 | 40.85 | 28.35 |
| 110° | 23.50 | 40.20 | 29.32 |

TABLE 2

| Sample of starting substrate - | | | |
|---|---|---|---|
| iron oxide coated mica | | | |
| (Angle following the ASTM | | | |
| E-2194 and DIN 6175-2 | | | |
| standards) | L | a* | b* |
| 15° | 79.40 | 65.75 | 24.27 |
| 25° | 63.12 | 54.43 | 23.58 |
| 45° | 43.03 | 39.12 | 27.63 |
| 75° | 37.17 | 33.48 | 31.48 |
| 110° | 35.16 | 33.57 | 32.00 |

As is clear from Tables 1 and 2 above, the use of the colored platelet obtained in Example 2 provided higher a* values (more positive a* values) as compared to those provided by using the starting substrate in Example 2. These results indicate that the colored platelet obtained in Example 2 can provide a superior bright red color effect.

### Example 9

Same as Example 8, except that 1 g of colored platelets prepared in Example 7 rather than the colored platelets prepared in Example 2 were dispersed into the resin system, and only a base coat film was obtained via drawdown, that is, no clear coat was applied. The results of the CIE lab measurements are shown in Table 3.

### Comparative Example 9

Same as Example 9, except that 1 g of the starting titania coated mica in Example 7 instead of the colored platelet prepared in Example 7 was used. The results of the CIELab measurements are shown in Table 4.

TABLE 3

| Sample from example 7 | | | |
|---|---|---|---|
| (Angle following the ASTM | | | |
| E-2194 and DIN 6175-2 | | | |
| standards) | L | a* | b* |
| 15° | 99.28 | −13.71 | −51.09 |
| 25° | 80.08 | −21.21 | −21.51 |
| 45° | 70.42 | −23.16 | −2.19 |
| 75° | 70.10 | −25.52 | −0.15 |
| 110° | 68.98 | −29.04 | −6.79 |

TABLE 4

| Sample of starting substrate - | | | |
|---|---|---|---|
| titania coated mica | | | |
| (Angle following the ASTM | | | |
| E-2194 and DIN 6175-2 | | | |
| standards) | L | a* | b* |
| 15° | 136.39 | −14.11 | −18.41 |
| 25° | 94.09 | −15.39 | −14.32 |
| 45° | 64.36 | −17.71 | −13.59 |
| 75° | 59.93 | −19.61 | −14.06 |
| 110° | 61.39 | −23.40 | −17.83 |

As is clear from Tables 3 and 4 above, the use of the colored platelet obtained in Example 7 provided much more negative b* values as compared to those provided when using the starting substrate in Example 7. These results indicate that the colored platelet obtained in Example 7 can provide a superior bright dark blue color effect.

### SEM Image Analysis

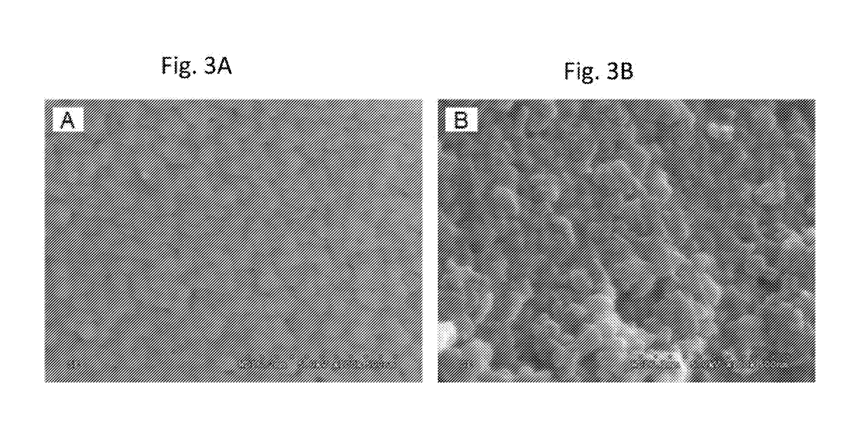

Samples were mounted on an aluminum stub via a piece of double-sided conductive carbon tape using a clean laboratory spatula. The extra powder was purged away by nitrogen before introduction into the analytical chamber of SEM. Clean tweezers and gloves were used for all sampling handling. The samples were placed in the analytical chamber which was then evacuated to <1×10⁻⁵ torr. All microscopy was done at a working distance of 15 mm. FIG. 3A is the SEM image of the substrate before coating and FIG. 3B is the SEM image of the surface after multilayer coating.

As discussed above, the pigment(s) herein can be used in coatings, inks, plastics and other general industrial coatings.

While the disclosed pigments and methods have been described in conjunction with some particular embodiments, it will be apparent to one skilled in the art that other objects and refinements of the disclosed pigments and methods may be made within the purview and scope of the disclosure. The disclosure, in its various aspects and disclosed forms, is well adapted to the attainment of the advantages of others. The disclosed details are not to be taken as limitations on the claims.

What is claimed is:

1. A colored platelet, comprising:
a substrate;
an adhesion layer that surrounds the substrate; and
a color pigment layer, the color pigment layer including color pigments that are attached to the adhesion layer.

2. The colored platelet of claim 1, wherein the substrate is non-metal.

3. The colored platelet of claim 1, wherein the substrate includes at least one selected from the group consisting of glass, silicon oxide, mica, and aluminum oxide.

4. The colored platelet of claim 1, further comprising an oxide layer that surrounds the substrate.

5. The colored platelet of claim 4, wherein the oxide layer includes at least one selected from the group consisting of iron oxide, silicon dioxide, titanium dioxide and zirconium dioxide.

6. The colored platelet of claim 1, further comprising a secure layer that secures the color pigments to the adhesion layer.

7. The colored platelet of claim 6, wherein the secure layer is an oxide layer, metal particles layer or a polymer layer.

8. The colored platelet of claim 7, wherein the secure layer is an oxide layer which includes at least one selected from the group consisting of SiO₂, TiO₂, and ZrO₂.

9. The colored platelet of claim 1, wherein the substrate is mica, the substrate is coated with iron oxide, and the color pigments include at least one selected from the group consisting of quinacridone, perylene, anthroquinone, diketo-pyrrolo pyrrole, and dioxazine.

10. The colored platelet of claim 1, wherein the substrate is mica, the substrate is coated with titanium dioxide, and the color pigments include at least one selected from the group consisting of phthalocyanine, Prussian blue and cobalt blue.

11. The colored platelet of claim 1, wherein the adhesion layer includes an amino group.

12. The colored platelet of claim 11, wherein the amino group is a tertiary amine.

13. The colored platelet of claim 1, wherein the color pigments include at least one selected from the group consisting of quinacridone, perylene, perinone, thioindigo pigments, azo pigments, diazo pigments, benzimidazole pigments, naphthene pigments, metal complex pigments, isoindolinone pigments, isoindoline pigments, indigo, quinophthalone pigments, dioxazine pigments, anthraquinone, and diketopyrrolopyrrole (DPP).

14. A method of producing the colored platelet of claim 1, comprising:
dispersing a substrate in a solvent to form a substrate dispersion;
adding an aminosilane to the substrate dispersion so as to form the adhesion layer; and
adding a color pigment dispersion to the substrate dispersion so as to form the color pigment layer.

15. The method of claim 14, wherein the color pigment dispersion is formed by dispersing color pigments in a solvent.

16. A coating composition, comprising:
the colored platelet of claim 1, and
a carrier.

17. The coating composition of claim 16, wherein the coating composition has a bright red color effect.

18. The coating composition of claim 16, wherein the coating composition has a bright dark blue color effect.

19. An article comprising:
a surface having a coating that comprises the colored platelet of claim 1.
